(19) United States
(12) Patent Application Publication
(10) Pub. No.: US 2008/0189387 A1
(43) Pub. Date: Aug. 7, 2008

(54) Instant messenger system with accessible group contact list

(76) Inventor: Ching-Kang Lee, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/969,230

(22) Filed: Jan. 4, 2008

Related U.S. Application Data
(60) Provisional application No. 60/888,324, filed on Feb. 6, 2007.

(51) Int. Cl. G06F 15/16

(52) U.S. Cl. 709/217

(57) ABSTRACT

A method for changing a user A's contact list of an instant messenger system includes the user A transmitting a request to a user B, and adding the user B's contact list to the user A's contact list after the user B accepts the user A's request.

### CROSS REFERENCE TO RELATED APPLICATIONS

This application claims the benefit of U.S. Provisional Application No. 60/888,324 which was filed on Feb. 6, 2007 and is included herein by reference.

### BACKGROUND OF THE INVENTION

1. Field of the Invention

The present invention relates to an instant messenger system, and more particularly, to an instant messenger system with accessible group contact list.

2. Description of the Prior Art

Conventional instant messenger system, such as MSN Messenger, allows a first user registered onto the server to add an account of a second user registered on the same server as a contact. And if the second user accepts the request of the first user, the account of the first user is also added into the second user's contact list. Then the first user and the second user can send messages to each other.

The drawback of the conventional instant messenger system is that the user has to respectively transmit a request to each contact for adding the contact into the user's contact list. Therefore, if the user wants to add many other users into his contact list, he has to manually transmit requests for that many times as the amount of the other users, which is a great inconvenience.

### SUMMARY OF THE INVENTION

The present invention provides a method for changing a contact list of a first user of an instant messenger system. The method comprises the first user transmitting a request to a second user, and adding a contact list of the second user to the contact list of the first user after the second user accepts the request of the first user.

The present invention further provides a method for changing a contact list of a first user of an instant messenger system. The method comprises a second user transmitting a request to the first user, and adding a contact list of the second user to the contact list of the first user after the first user accepts the request of the second user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an instant messenger system of the present invention.

FIG. 2 is a diagram illustrating the contact list of the user.

FIG. 3 is a diagram illustrating one user transmitting a request to another user for adding the requested user into the requesting user's contact list.

FIG. 4 is a diagram illustrating the contact list of the requesting user after the requesting user adds the requested user into the requesting user's contact list.

FIG. 5 is a diagram illustrating the contact list of another user.

FIG. 6 is a diagram illustrating the requesting user transmitting a request to another user for adding the requested user into the requesting user's contact list.

FIG. 7 is a diagram illustrating the contact list of the requesting user after the requesting user adds the requested user into the requesting user's contact list and the requesting user adds the another requested user into the requesting user's contact list.

FIG. 8 is a diagram illustrating the contact list of the requested user after the requesting user adds the requested user into the requesting user's contact list.

FIG. 9 is a diagram illustrating the contact list of another user after the requesting user adds the requested user into the requesting user's contact list.

FIG. 10 is a diagram illustrating the situation after the requested user deletes the requesting user from the requested user's contact list.

### DETAILED DESCRIPTION

Thus, the present invention provides an instant messenger system allowing a first user to add the contact list of a second user into the first user's contact list if the second user accepts the request of the first user, and vice versa.

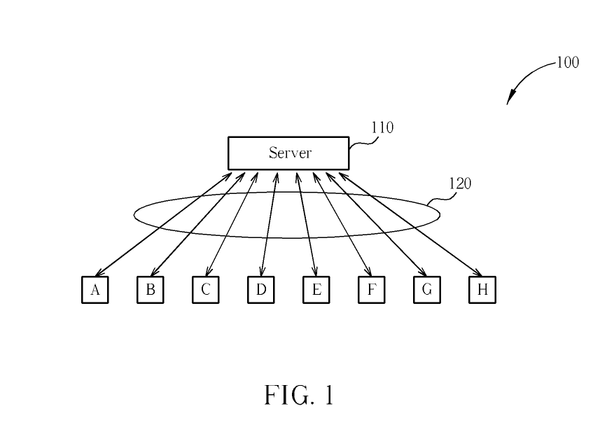

Please refer to FIG. 1. FIG. 1 is a diagram illustrating an instant messenger system 100 of the present invention. The instant messenger system 100 comprises a server 110, a network 120, and a plurality of users. It is assumed that 8 users A, B, C, D, E, F, G, and H are registered onto the server 110 through the network 120.

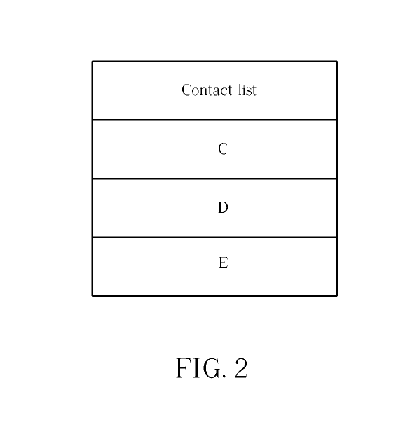

Please refer to FIG. 2. FIG. 2 is a diagram illustrating the contact list of the user B. It is assumed that the contact lists of all the users A to H are empty. As shown in FIG. 2, the contact list of the user B comprises the users C, D, and E. There are two conditions enabling the contact list of B comprising the users C, D, and E. Condition 1: The user B sends requests S1 respectively to the users C, D, and E for adding the users C, D, E into the contact list of the user B. As shown in FIG. 2, the user B adds the users C, D, and E into his contact list. Thus, the user B can send instant messages to the users C, D, and E. Additionally, after accepting the request S1 of the user B, the user B is added into the contact lists of the users C, D, and E so that the contact lists of the users C, D, and E has a contact “user B” rather than emptiness. It is selectable that the contact list of the user B is transmitted to the users C, D, and E. If the contact list of the user B is selected to be transmitted to the users C, D, and E, the contact list of the user C comprises the users B, D, and E, the contact list of the user D comprises the users B, C, and E, and the contact list of the user E comprises the users B, C, and D. If the contact list of the user B is selected not to be transmitted to the users C, D, and E, the contact list of the user C only comprises the user B, the contact list of the user D only comprises the user B, and the contact list of the user E comprises the user B. It is also selectable that the contact list of the users C, D, and E are transmitted to the user B. This situation is similar to the situation described above and is omitted. Condition 2: The users C, D, and E respectively send requests S1 to the user B for adding the user B respectively into the contact lists of the users C, D, and E. Therefore, the contact list of the user C comprises the user B, the contact list of the user D comprises the user B, and the contact list of the user E comprises the user B. Thus, the users C, D, and E can send instant messages to the user B. Additionally, after accepting the request S1 of the users C, D, E, the user C, D, and E are also added into the contact list of the user B so that the contact lists of the user B has contacts “users C, D, and E” rather than emptiness. It is selectable that the contact list of the users C, D, and E are transmitted to the user B. And it is also selectable that the contact list of the user B is transmitted to the users C, D, and E. The related description is similar to those described above and is omitted.

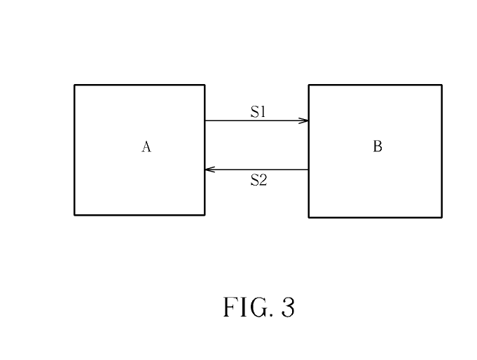

Please refer to FIG. 3. FIG. 3 is a diagram illustrating the user A transmitting a request S1 to the user B for adding the user B into the user A's contact list. As shown in FIG. 3, the user A transmits a request S1 to the user B. If the user B accepts the request S1, the user B transmits an agreement S2 to the user A, and then the user A and the user B can send messages to each other.

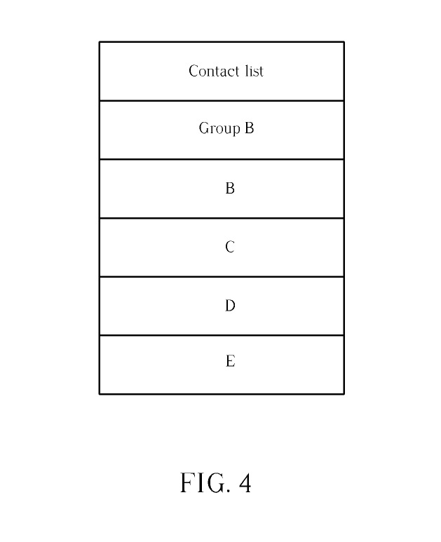

Please refer to FIG. 4. FIG. 4 is a diagram illustrating the contact list of the user A after the user A adds the user B into the user A's contact list. As shown in FIG. 4, if the user B decides to give the contact list of the user B to the user A, then besides the user B, the contact list of A comprises the users of the contact list of the user B: C, D, and E. After the user B accepts the request S1 of the user A, the contact list of the user B is added into the contact list of the user A. Therefore, the user A only has to transmit a request S1 for one time to the user B and obtains the contact list of the user B, which is more convenient than the prior art. In this way, the user A can communicate with the users B, C, D, and E. However, the user B still can decide not to give the contact list of the user B to the user A. If the user B decides not to give the contact list of the user B to the user A, then the contact list of the user A is only added with the user B, which means the user A only can communicate with the user B. Thus, as shown in FIG. 4, the contact list of the user A comprises a group B (the contact list of the user B), and the users C, D, and E are in the group B.

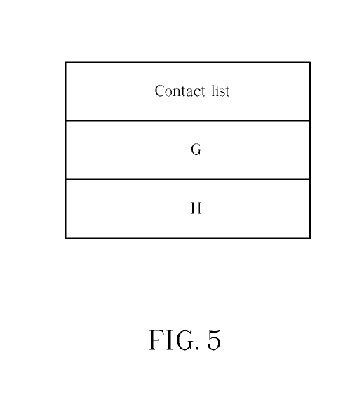

Please refer to FIG. 5. FIG. 5 is a diagram illustrating the contact list of the user F. The user F sends requests S1 respectively to the users G and H for adding the users G and H into the contact list of the user F. As shown in FIG. 5, the user F adds the users G and H into his contact list. Thus, the user F can send instant messages to the users G and H. Additionally, after accepting the request S1 of the user F, the user F is added into the contact lists of the users G and H so that the contact lists of the users G and H has a contact “user F” rather than emptiness.

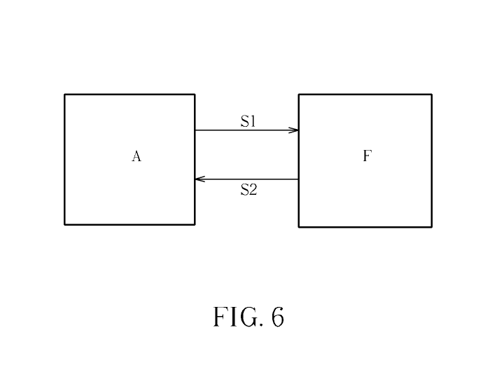

Please refer to FIG. 6. FIG. 6 is a diagram illustrating the user A transmitting a request S1 to the user F for adding the user F into the user A's contact list. As shown in FIG. 6, the user A transmits a request S1 to the user F. If the user F accepts the request S1, the user F transmits an agreement S2 to the user A, and then the user A and the user F can send messages to each other.

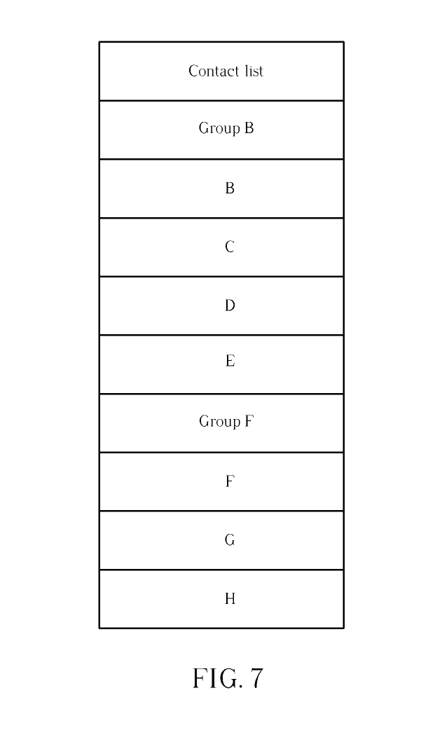

Please refer to FIG. 7. FIG. 7 is a diagram illustrating the contact list of the user A after the user A adds the user B into the user A's contact list and the user A adds the user F into the user A's contact list. As shown in FIG. 7, besides the user F, the contact list of A comprises the users of the contact list of the user F: G and H. After the user F accepts the request S1 of the user A, the contact list of the user F is added into the contact list of the user A. Therefore, the user A only has to transmit a request S1 for one time to the user F and obtains the contact list of the user F, which is more convenient than the prior art. Thus, as shown in FIG. 7, the contact list of the user A comprises a group B previously added in, and a group F (the contact list of the user F), and the users G and H are in the group F.

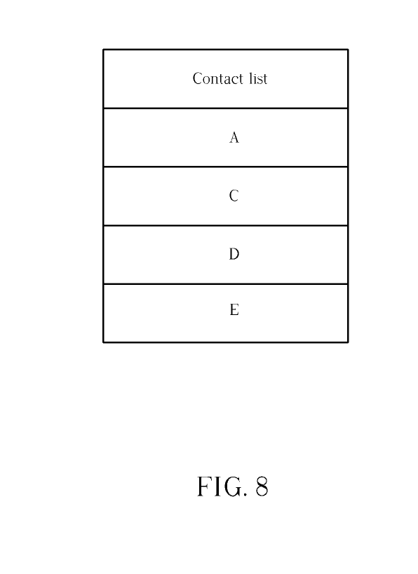

Please refer to FIG. 8. FIG. 8 is a diagram illustrating the contact list of the user B after the user A adds the user B into the user A's contact list. As shown in FIG. 8, besides the originally added users C, D, and E, the contact list of B further comprises the user A. Thus, each user in the user B's contact list can see the user A. That is, after the user A adds the user B into the A's contact list, the user B also adds the user A into the user B's contact list and provide the user B's contact list to the user A. In this way, the user A can communicate with the users C, D, and E.

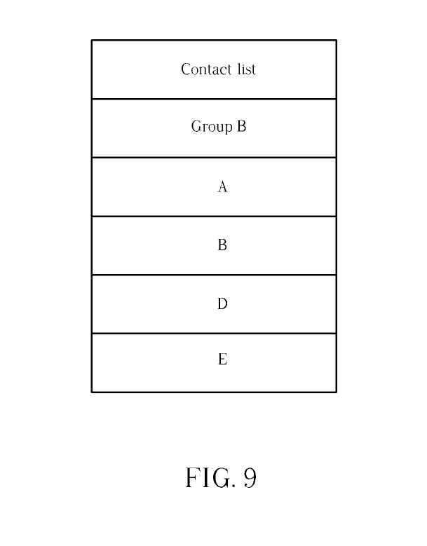

Please refer to FIG. 9. FIG. 9 is a diagram illustrating the contact list of the user C after the user A adds the user B into the user A's contact list. As shown in FIG. 9, besides the originally added users B, D, and E in the group B of the user C's contact list, the user A is also added into the group B of the user C's contact list.

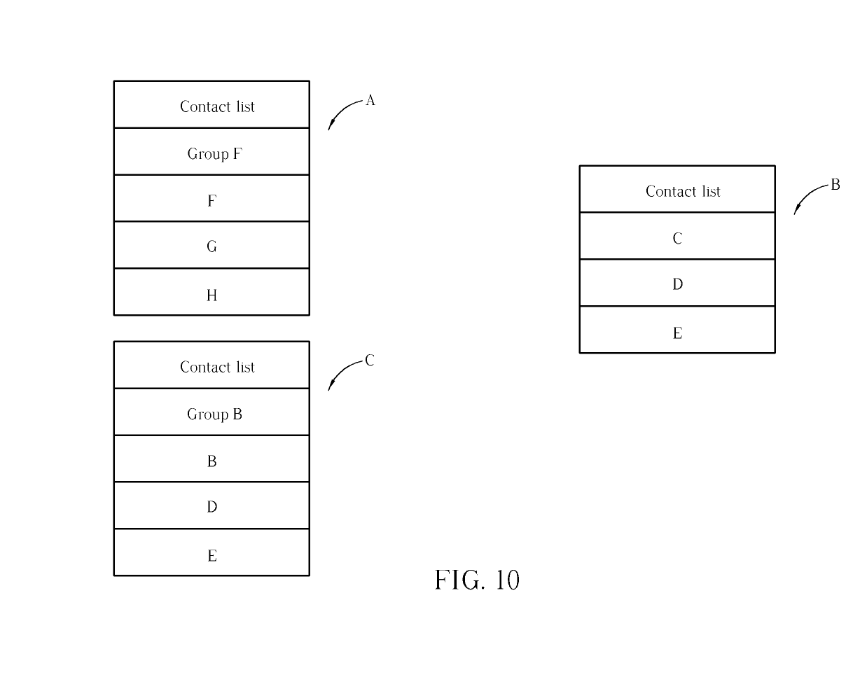

Please refer to FIG. 10. FIG. 10 is a diagram illustrating the situation after the user B deletes the user A from the user B's contact list. If the user B deletes the user A out from the user B's contact list, the user A will no longer see any user on the user B's contact list, which means the contact list of the user B is deleted from the contact list of the user A. And all the users in the user B's contact list will also be unable to see the user A. As shown in FIG. 10, it is only the group F left in the contact list of the user A, thus the user A only can communicate with the users F, G, and H. in the user B's contact list, the user A does not exist in the list so that the users C, D, and E cannot communicate with the user A. Consequently, in the contact list of the user C, there is no user A of the group B on the list.

Under the assumption that the user B adds the users C, D, and E into the user B's contact list and the user F adds the users G and H into the user F's contact list, in the instant messenger system of the prior art, the user A has to send requests S1 for 7 times to add the users B to H into the contact list of the user A. In the present invention, the user A only has to send requests S1 for 2 times to add the users B to H into the contact list of the user A.

Now we apply the instant messenger system 100 of the present invention onto enterprises. It is assumed that the users B and F are companies, and the users A, C, D, E, G, H are employees. The company B has 3 employees C, D, and E. The company F has 2 employees G and H. If the user A becomes an employee of the company B, he does not have to add the employees of the company B one by one for building his own contact list. Instead, the company B gives the employee A the contact list of all the employees of the company B. Therefore, the employee A can send instant messages to all the employees of the company B. If the user A further becomes an employee of the company F, he does not have to add the employees of the company F one by one for building his own contact list. Instead, the company F gives the employee A the contact list of all the employees of the company F. Therefore, the employee A can send instant messages to all the employees of the company F. In this way, the user A are employee of the companies B and F, and the user A can transmit instant messages to the employees C, D, and E of the company B and to the employees G and H of the company F. If the user A leaves the company B, the company B deletes the user A from the contact list of the company B. Consequently, the part of the company B is deleted from the contact list of the user A so that the user A only can contact with the company F, the users G and H. This way provides the manager of the company B easily managing the instant messenger system between the company and the employees.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for changing a contact list of a first user of an instant messenger system, the method comprising:
the first user transmitting a request to a second user; and
adding a contact list of the second user to the contact list of the first user after the second user accepts the request of the first user.

2. The method of claim 1 further comprising:
labeling the contact list of the second user in the contact list of the first user as a first group.

3. The method of claim 1 further comprising:
deleting the contact list of the second user from the contact list of the first user after the second user is deleted from the contact list of the first user.

4. The method of claim 1 further comprising:
adding the contact list of the first user to the contact list of the second user after the second user accepts the request of the first user.

5. The method of claim 4 further comprising:
labeling the contact list of the first user in the contact list of the second user as a group.

6. The method of claim 5 further comprising:
deleting the contact list of the first user from the contact list of the second user after the first user is deleted from the contact list of the second user.

7. The method of claim 2 further comprising:
the first user transmitting a request to a third user; and
adding a contact list of the third user to the contact list of the first user after the third user accepts the request of the first user.

8. The method of claim 7 further comprising:
labeling the contact list of the third user in the contact list of the first user as a second group for differentiating from the first group.

9. A method for changing a contact list of a first user of an instant messenger system, the method comprising:
a second user transmitting a request to the first user; and
adding a contact list of the second user to the contact list of the first user after the first user accepts the request of the second user.

10. The method of claim 9 further comprising:
labeling the contact list of the second user in the contact list of the first user as a first group.

11. The method of claim 9 further comprising:
deleting the contact list of the second user from the contact list of the first user after the second user is deleted from the contact list of the first user.

12. The method of claim 10 further comprising:
the first user transmitting a request to a third user; and
adding a contact list of the third user to the contact list of the first user after the third user accepts the request of the first user.

13. The method of claim 12 further comprising:
labeling the contact list of the third user in the contact list of the first user as a second group for differentiating from the first group.
